(19) United States
(12) Patent Application Publication
(10) Pub. No.: US 2010/0192896 A1
(43) Pub. Date: Aug. 5, 2010

(54) INTERNAL COMBUSTION ENGINES WITH RING-SHAPED CYLINDERS

(76) Inventor: Dianlin Chang, Shenyang (CN)

Correspondence Address: PERKINS COIE LLP;PATENT-SEA, P.O. BOX 1247, SEATTLE, WA, 98111-1247, US

(21) Appl. No.: 12/756,936

(22) Filed: Apr. 8, 2010

Related U.S. Application Data
(63) Continuation of application No. PCT/CN2008/001566, filed on Sep. 2, 2008.

(30) Foreign Application Priority Data
Oct. 16, 2007 (CN) 200710157480.2
Oct. 16, 2007 (CN) 200710157481.7

(51) Int. Cl. F02F 1/00

(52) U.S. Cl. 123/193.2

(57) ABSTRACT

An internal combustion engine having ring shaped cylinder is disclosed herein. In one embodiment, an internal combustion engine includes an engine body and a ring-shaped cylinder in the engine body. The ring-shaped cylinder has a center and an outer circumference spaced radially apart from the center. The internal combustion engine further includes a plurality of synchronizing valves at least proximate the outer circumference of the ring-shaped cylinder so that the ring-shaped cylinder is divided into a plurality of cylinder portions. The synchronizing valve has a valve shaft and a valve opening. The internal combustion engine further includes a rotor at the center of the ring-shaped cylinder, and the rotor has isolation blocks extending from the rotor toward the outer circumference of the ring-shaped chamber. The valve openings are configured to receive the isolation blocks and to form seals in the ring-shaped cylinder.

### CROSS-REFERENCE TO RELATED APPLICATION

This application claims priority to PCT Application No. PCT/CN2008/001566, filed on Sep. 2, 2008 which further claims priority to Chinese Patent Application Nos. 200710157480.2 and 200710157481.7, the disclosures of which are incorporated herein by reference in their entirety.

### TECHNICAL FIELD

The present disclosure is related to internal combustion engines. In particular, the present disclosure is related to internal combustion engines with a ring-shaped cylinder and associated methods of operation.

### BACKGROUND

The German technician named Karl Benz was credited to invent the first modern automobile in 1886. The automobile he invented was a tricycle carrying a gasoline internal combustion engine. Since then, the automobiles have “compressed” time and space of modern living, changed lifestyles of countless people, and effectively improved labor productivity.

Most conventional engines have a reciprocating piston configuration. One exception is the Wankel engine, which has a rotary configuration. However, the Wankel rotary engine has not been widely used due to manufacturing complexity and high costs. Therefore, the vast majority of internal combustion engines in the market today have the reciprocating piston configuration.

The reciprocating piston type engines are mechanically complex and have low efficiencies. For example, one four-cylinder four-stroke engine typically include hundreds if not thousands of individual components. In operation, only one stage of the four-stroke cycle produces work while the remaining three stages consume energy. With other losses in connecting links and other mechanical components, reciprocating piston type engines typically have energy-to-work efficiencies below 30%. Accordingly, there is a need in the art for internal combustion engines that have low manufacturing costs and high energy-to-work efficiency.

### BRIEF DESCRIPTION OF THE DRAWINGS

FIG. 1 is a partially exploded front view of an internal combustion engine in accordance with embodiments of the technology.

FIG. 2 is a side elevation view of the internal combustion engine in FIG. 1.

FIG. 3 is an enlarged view of an isolation block useful in the internal combustion engine of FIG. 1 in accordance with embodiments of the technology.

FIG. 4 is a side elevation view of the isolation block in FIG. 3.

FIG. 5 is a schematic view of a synchronizing valve useful in the internal combustion engine of FIG. 1 in accordance with embodiments of the technology.

FIG. 6 is a side elevation view of the synchronizing valve in FIG. 5.

FIG. 7 is a partially exploded front view of an internal combustion engine in accordance with additional embodiments of the technology.

FIG. 8 is a schematic view of an isolation block useful in the internal combustion engine of FIG. 7 in accordance with embodiments of the technology.

FIG. 9 is a side view of the isolation block in FIG. 8.

FIG. 10 is a schematic view of an isolation block in accordance with additional embodiments of the technology.

FIG. 11 is a schematic view of an isolation block in accordance with further embodiments of the technology.

### DETAILED DESCRIPTION

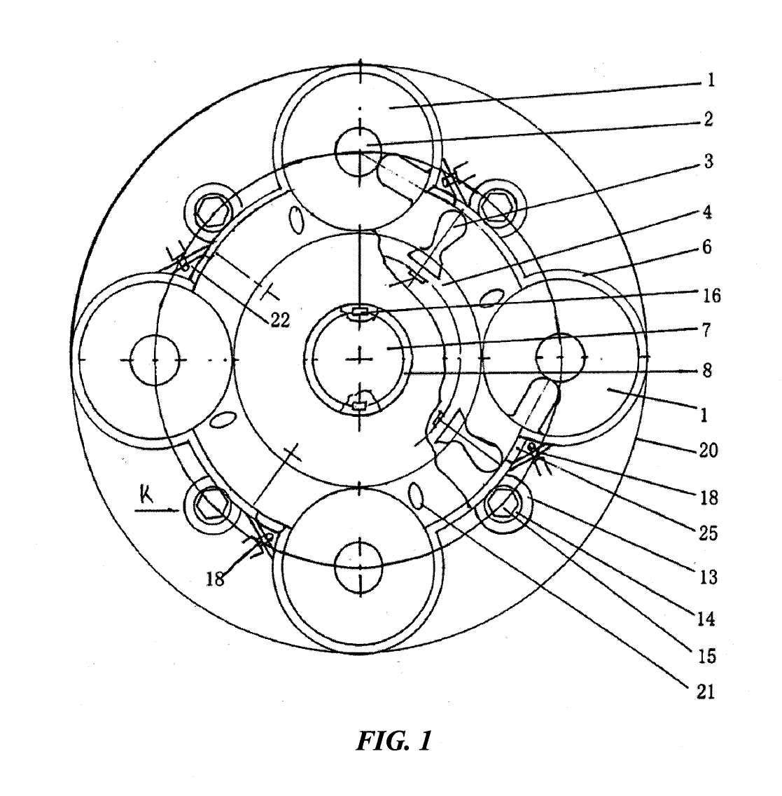

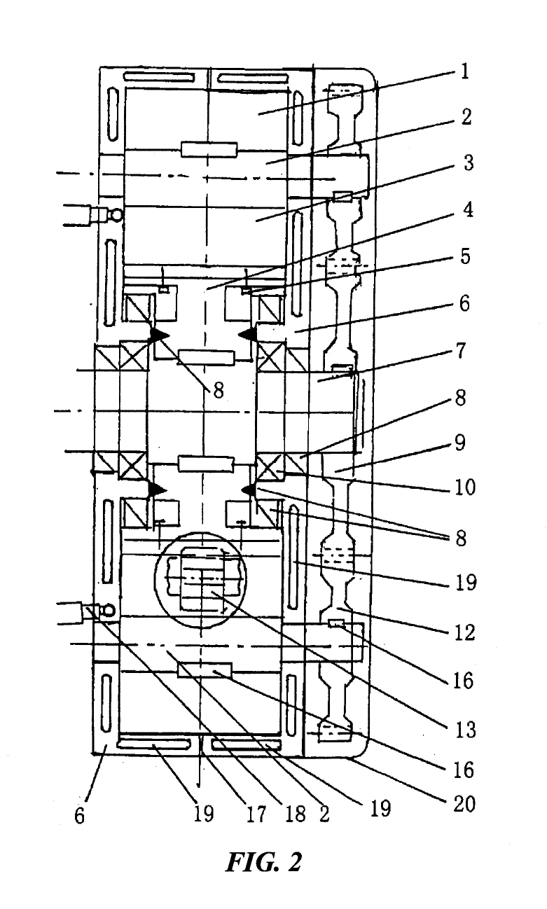

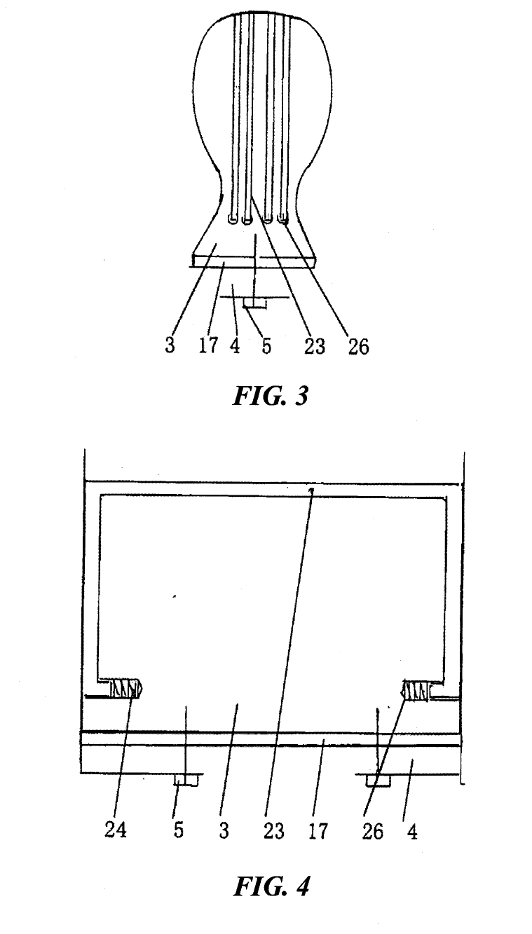

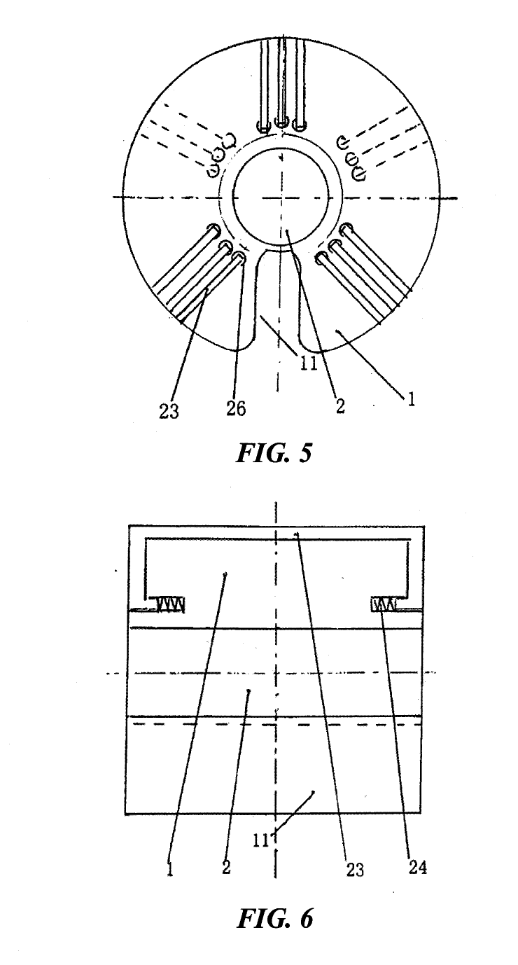

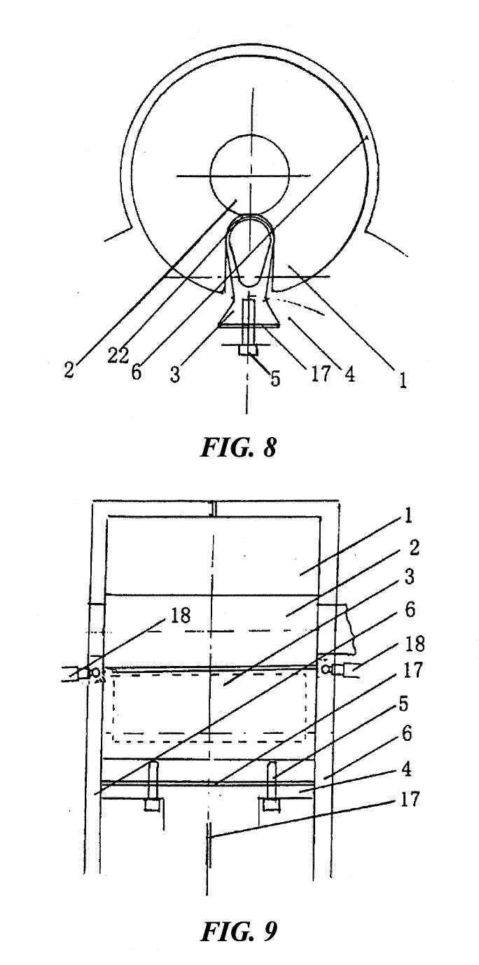

Specific details of several embodiments of the disclosure are described below with reference to internal combustion engines with a ring-shaped cylinder and associated methods of operation. The term “internal combustion engine” generally refers to an engine in which the combustion of a fuel (e.g., gasoline, diesel, and/or other types of suitable fuels) occurs with an oxidizer (e.g., air) in a combustion chamber of the engine. Several embodiments can have configurations, components, or procedures different than those described in this section, and other embodiments may eliminate particular components or procedures. A person of ordinary skill in the relevant art, therefore, may understand that the technology can have other embodiments with additional elements, and/or can have other embodiments without several of the features shown and described below with reference to FIGS. 1-11.

Several embodiments of the technology are directed to an internal combustion engine with improved energy efficiency and reduced mechanical complexity. The internal combustion engine can include an engine body with a ring-shaped cylinder and a plurality of synchronizing valves at least proximate to the outer circumference of the ring-shaped cylinder. The synchronizing valves can individually have a valve shaft and a valve opening.

The internal combustion engine can also include a rotor at a center of the ring-shaped combustion chamber and a plurality of isolation blocks on the rotor. The rotor can be coupled to an output shaft and/or other suitable components for outputting mechanical energy. In certain embodiments, a top portion of the isolation blocks can be hollow. In other embodiments, the isolation block can include at least one of a wedged block mount on the rotor; a securing screw or rivet at the top portion of the wedged block mount. In further embodiments, the isolation blocks can be bowl-shaped or dish-shaped and are coupled with the securing screw or rivet. Spacers can be between the adjacent bowl-shaped or dish-shaped isolation blocks and can also be on the securing screw or rivet between the bowl-shaped or dish-shaped isolation blocks and the wedged block mount. In yet further embodiments, the isolation blocks can also include other suitable components and/or configurations.

During operation, the rotor, the top portion of the isolation blocks, and the valve openings of the synchronizing valves can form a combustion/compression chamber. The internal combustion chamber can also include a fuel nozzle to the combustion/compression chamber and a gas discharging valve with an opening to the ring-shaped cylinder. In certain embodiments, the synchronizing valve shafts are coupled with respective pinions, for example, though a key. The output shaft can be coupled with a bull gear, for example, through another key, and the bull gear and the pinions are engaged with one another. A bearing or bushing can be provided on the output shaft.

The isolation block and the valve opening are configured such that an elastic sealing can be achieved therebetween. For example, in certain embodiments, a sealing gasket is positioned between the bottom surface of the isolation block and the rotor, and the sealing gasket can be fixed on the isolation block with a screw and/or other suitable fastener. In other embodiments, other sealing mechanisms may also be used.

In certain embodiments, the individual synchronizing valves can include positioning holes and seals and/or sealing rings on the outer circumference of the synchronizing valves. Both ends of the seals can be locked in the positioning holes in the synchronizing valves with, for example, springs between both ends of the seals. As discussed in more detail below, three to five sets of seals can be provided on the synchronizing valves and each set can include three to five individual seals. In other embodiments, the individual synchronizing valves can also include any other desired number of sets of seals and/or number of seals in an individual set.

In certain embodiments, the internal combustion engine can also include sealing rings between the rotor and the engine body, between the bearing and the engine body, and/or between the bearing and the rotor. A protective cover can be at one side of the engine body where the synchronizing valve shafts and the output shaft extend from the engine body. In several embodiments, the internal combustion engine can include an anti-vibration mounting and/or an anti-vibration rubber sleeve for the engine body. The anti-vibration mounting and the anti-vibration rubber sleeve can be fixed to a vehicle frame through a bolt and/or other suitable fasteners. A coolant passage can also be in the engine body. In other embodiments, the internal combustion engine may be mounted via other suitable techniques.

Several embodiments of the internal combustion engine can have simpler structures and higher volume-to-power output ratios than conventional reciprocating piston type engines. Several embodiments of the internal combustion engine can at least reduce or even eliminate vibration and energy consumption of the reciprocating pistons at the upper and lower stroke dead ends in the conventional engine. It has been shown that the fuel consumption of several embodiments of the internal combustion engine in accordance with the present technology can be ⅓ to ½ less than certain conventional reciprocating piston type engines.

Several particular embodiments of the internal combustion engine in accordance with the present technology are described below. The described embodiments with respect to different figures may have components that are generally similar in structure and/or function. As a result, common acts and structures are identified by common reference numbers.

FIGS. 1-6 illustratively show a first embodiment of an internal combustion engine in accordance with the present technology. As shown in FIGS. 1-6, the internal combustion engine includes a ring-shaped cylinder in an engine body 6. In the illustrated embodiment, the engine body 6 includes an upper body, a lower body, and at least one sealing ring between the upper and the lower bodies. In other embodiments, the engine body 6 may also be a unitary component or may include three, four, or any other desired number of body components.

Synchronizing valves 1 can be located on the outer circumference of the ring-shaped cylinder and individually have a valve opening 11. A rotor 4 can be at the center of the ring-shaped cylinder with a plurality of isolation blocks 3 on the rotor 4. The isolation blocks 3, the synchronizing valves 1, and the ring-shaped cylinder are configured in such a way that sealing is achieved (1) between the individual isolation blocks 3 and the corresponding synchronizing valves 1 and (2) between the isolation blocks 3 and the ring-shaped cylinder.

Combustion chambers 22 can be formed in the engine body 6 at a side proximate to the synchronizing valves 1. An injection window 25 can be at the individual combustion chambers 22. A seal 23 is located on a surface of the isolation block 3, which is at least approximately tangent to the synchronizing valves 1 and the ring-shaped cylinder.

The isolation block 3 can include positioning holes 26. Both ends of the seals 23 can be engaged or locked in the positioning holes 26 of the isolation block 3 with springs 24 and/or other suitable fasteners in the positioning holes 26 between both ends of the seals 23. In the illustrated embodiment, the isolation block 3 has four seals, though any other desired number of seals may also be used. Both sides of the isolation block 3 are configured to produce elastic sealing between both sides of the isolation block 3 and the side walls of the valve opening 11.

In the illustrated embodiment, a gasket 17 is between a bottom surface of the isolation block 3 and the rotor 4. The gasket 17 can be fixed on the isolation block 3 via a screw 17. In certain embodiments, each isolation block 3 can have one to thirty sets of screws. In other embodiments, any other desired number of screws may also be used. In further embodiments, other suitable sealing components may be used between the bottom surface of the isolation block 3 and the rotor 4.

The internal combustion engine can also include one, two, or other desired number of nozzles 18 in the combustion chamber 22. In embodiments with only one nozzle 18, both fuel and exhaust gases can pass through the nozzle 18. In other embodiments with two nozzles 18, fuel can pass through a first nozzle 18 while exhaust gases can pass through a second nozzle 18. In further embodiments, other injection and/or exhaust configurations may be used.

The internal combustion engine can also include gas discharging valves 21 with openings to the ring-shaped cylinder. The gas discharging valves 21 can connect with a gas discharging pipe and a muffler and/or other suitable exhaust components (not shown). The gas discharging windows 25 can be arranged at respective locations where the gas discharging valves 21 connect with the ring-shaped cylinder. The gas discharging windows 25 can be in conformity with the inner surface of the ring-shaped cylinder in flatness and smoothness.

In the illustrated embodiment, the synchronizing valve 1 can include a synchronizing valve shaft 2, and the rotor 4 is coupled with an output shaft 7 via a key 16-3. The synchronizing valve shaft 2 is coupled with a pinion 12 though a key 16-1, and the output shaft 7 is coupled with a bull gear 9 through a key 16-2. The bull gear 9 and the pinion 12 are engaged so that the synchronizing valve shaft 2 and the output shaft 7 can synchronously rotate. In other embodiments, other synchronizing mechanisms may also be used.

In the illustrated embodiment, a bearing (or bushing) 10 is on the output shaft 7. Sealing rings 8-1, 8-2, and 8-3 are between the rotor 4 and the engine body 6, between the bearing 10 and the engine body 6, and between the bearing 10 and the rotor 4. Thus, in the illustrated embodiment, three sets of sealing structures are at both sides of the rotor 4. In other embodiments, the internal combustion engine may include other sealing mechanisms on the output shaft 7.

In the illustrated embodiment, the sealing structures include three-stage seals. However, in other embodiments, the number of the sealing rings can be increased or decreased based on power, pressure, temperature, and/or other characteristics of the particular engines. Typically, 2-10-stage seals can be used, though any number of stage seals may be used. The three-stage seals in the illustrated embodiment includes a high temperature sealing ring, an intermediate temperature sealing ring, and a low temperature sealing ring. Other configurations of the seals may also be suitable in other embodiments.

In the illustrated embodiment, a protective cover 20 is at one side of the engine body 6 where the synchronizing valve shafts 2 and the output shaft 7 extend out of the engine body 6. The engine body 6 at this side is detachable. In certain embodiments, the engine body 6 can be integrated with an anti-vibration mounting 13 which may include an anti-vibration rubber sleeve 14. The anti-vibration mounting 13 and the anti-vibration rubber sleeve 14 can be fixed on the vehicle frame via bolts 15. A coolant passage 19, which communicates with the engine cycle cooling system (not shown) to control the engine temperature, can be located in the engine body 6.

The internal combustion engine can also include seals or sealing rings 23 on the outer circumference of the synchronizing valve 1 and positioning holes 26 in the synchronizing valve 1. Both ends of the seals 23 can be locked in the positioning holes 26 in the synchronizing valve 1, and the diameter of the holes 26 can be slightly greater than the cross-section of the seals 23 so that the seals 23 may move within the holes 26.

Without being bound by theory, it is believed that the sealing quality can be enhanced by virtue of a centrifugal force when the synchronizing valve 1 is rotated. Springs 24 are between both ends of the seals 23 within the position limitation hole 26. In the illustrated embodiment, five sets of seals are provided on the synchronizing valve 1 and each set includes three seals, which are believed to improve the sealing quality by using resilient expansion sealing and centrifugal sealing. In other embodiments, any other desired number of sets of seals and/or number of seals in a set may be used.

When starting the internal combustion engine, a starter (not shown, e.g., an electrical motor) can drive the synchronizing valves 1 and pinions to rotate. The pinions in turn drive the bull gear, the rotor 4, and the isolation block 3 to rotate. After the isolation block 3 passes through the synchronizing valve opening 11, the isolation block 3, the synchronizing valve 1 and the rotor 4 form a sealed combustion chamber. A fuel (e.g., gasoline) is then injected into the combustion chamber via the nozzle 18 and subsequently ignited to push the isolation block 3 moving forward. After the fuel injection and combustion are completed, the exhaust gases are discharged via the gas discharging valves 21. The isolation block 3 drives the rotor 4 to rotate, and the rotor 4 drives the output shaft 7 to rotate so that the rotating momentum can be transmitted to a gear box (not shown) to drive wheels of a vehicle.

Even though the internal combustion engine shown in FIGS. 1-6 include four synchronizing valves 1, in other embodiments, the internal combustion engine can also include 2, 6, 8, 10, 20, 30, and/or other suitable number of synchronizing valves. In certain embodiments, the synchronizing valve 1 may be a solid structure. In other embodiments, the synchronizing valve 1 may be a hollow structure.

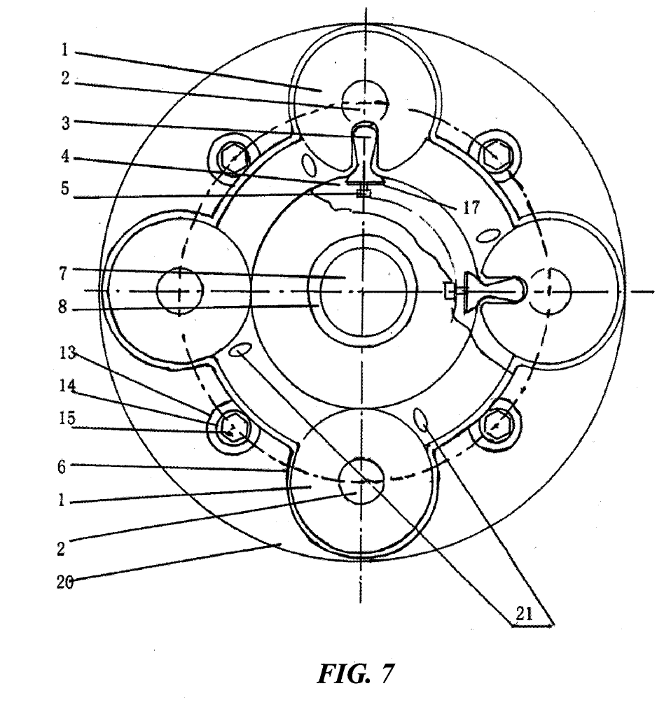

FIG. 7 shows another embodiment of the internal combustion engine in accordance with the present technology. The internal combustion engine in FIG. 7 can include certain components generally similar to those shown in FIGS. 1-6 except that the isolation blocks 3 are configured to compress a fuel in cooperation with the valve openings 11. In the illustrated embodiment, the upper portion of the isolation block 3 has a circular arch shape and is hollowed therein. The rounded head of the upper portion of the isolation block 3 can be relatively thin (e.g., about 1 mm to about 5 mm). When the isolation block 3 is moving into the valve opening 11, both sides of the isolation block 3 contact the side walls of the valve opening 11 so as to provide elastic sealing therebetween. In other embodiments, the isolation block 3 may include other suitable configurations for compressing a fuel in cooperation with the valve openings 11.

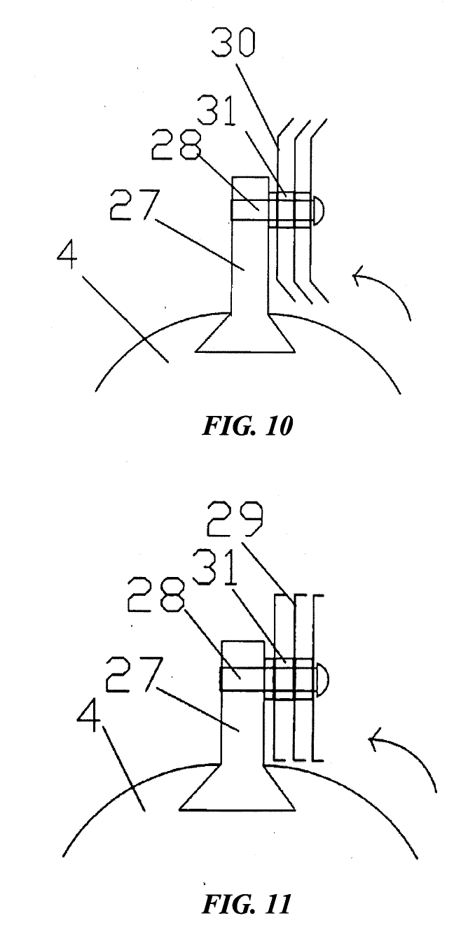

FIGS. 10 and 11 show additional embodiments of the isolation block 3. As shown in FIGS. 10 and 11, the isolation block 3 includes a wedged block mount 27 on the rotor 4. In the illustrated embodiment, the wedged block mount 27 is inserted into a wedge groove from the end portion of the rotor 4. As a result, the block mount 27 is wedged in the wedge groove of the rotor 4. A securing screw 28 or rivet on the top portion of the wedged block mount 27 can be used to further secure the wedged block mount 27. At least one of a bowl-shaped isolation block 29 or a dish-shaped isolation block 30 can be fixed on the securing screw 28 or rivet. When a plurality of bowl-shaped isolation blocks 29 or dish-shaped isolation blocks 30 are used, spacers 31 can be used between adjacent bowl-shaped isolation blocks 29 or dish-shaped isolation blocks 30, and on the securing screws 28 and rivets between the bowl-shaped isolation blocks 29 or dish-shaped isolation blocks 30 and the wedged block mount 27. The arrows shown in the FIGS. 10 and 11 indicate the moving direction of the isolation blocks 3.

During start-up, a starter (not shown, e.g., an electrical motor) drives the synchronizing valves 1 and pinions to rotate. The pinions drive the bull gear 9 to move, and the bull gear 9 drives the rotor 4 and the isolation blocks 3 to rotate. After the isolation block 3 passes through the synchronizing valve opening 11, sealing is formed between the surface of the synchronizing valve body and the inner wall of the cylinder. As the isolation block 3 is gradually inserted into the valve opening 11 (shown as a U-shaped opening, though other configurations may also be used), the valve opening 11 and the isolation block 3 form a sealed chamber, and the pressure of the chamber is increased with the insertion of the isolation block 3 because force is applied to the top portion of the isolation block 3.

As the top portion of the isolation block 3 is hollowed, the arch face at the peak of the top portion is slightly curved, depressed, and/or otherwise deformed. After the arch curve is pressed, both side walls of the isolation block 3 are expanded in both left and right directions so that tight sealing is achieved between both side walls of the isolation block 3 and the valve opening 11. The pressure in the sealed valve chamber is increased until a fuel compression ignition pressure is reached.

At this time, a fuel (e.g., diesel) is injected via the nozzle 18 and is ignited. The isolation block 3 is rapidly rotated under the push of the ignition pressure. After the sealing pressurization, fuel injection, compression ignition, and rotation are finished, the exhaust gases are discharged from the gas discharging valve opening 21. During operation, it is believed that when the ignited fuel pushes the arch face of the isolation block 3 the sealing pressure of the top surface of the isolation block 3, as well as the sealing between the isolation block 3 and the ring-shaped cylinder, are enhanced.

From the foregoing, it will be appreciated that specific embodiments of the technology have been described herein for purposes of illustration, but that various modifications may be made without deviating from the technology. For example, in certain embodiments, the bull gear 9 and the pinion can be replaced with synchronous belts, sprocket wheels, and/or chain transmission. In other embodiments, internal combustion engine can include two or more rotors in series on one output shaft 7 based on a desired power output requirement. Many of the elements of one embodiment may be combined with other embodiments in addition to or in lieu of the elements of the other embodiments. Accordingly, the technology is not limited except as by the appended claims.

I/we claim:

1. An internal combustion engine, comprising:
an engine body;
a ring-shaped cylinder in the engine body, the ring-shaped cylinder having a center and an outer circumference spaced radially apart from the center;
a synchronizing valve at least proximate to the outer circumference of the ring-shaped cylinder, the synchronizing valve having a valve opening; and
a rotor at the center of the ring-shaped cylinder, the rotor having an isolation block with a hollow portion proximate to the outer circumference of the ring-shaped cylinder, wherein the hollow portion of the isolation block and the valve opening of the synchronizing valve form a combustion chamber therebetween.

2. The internal combustion engine of claim 1 wherein:
the synchronizing valve includes a synchronizing valve shaft;
the internal combustion engine further includes
a pinion coupled to the synchronizing valve shaft;
an output shaft coupled to the rotor; and
a bull gear coupled to both the output shaft and the pinion.

3. The internal combustion engine of claim 1 wherein the isolation block and the valve opening are configured to achieve elastic sealing therebetween, and wherein the internal combustion engine further includes a gasket between the isolation block and the rotor.

4. The internal combustion engine of claim 1 wherein the synchronizing valve further includes:
a seal having a first end and a second end;
a plurality of positioning holes, both the first and second ends of the seal are locked in the positioning holes; and
a spring between both the first and second ends of the seal in the positioning hole.

5. The internal combustion engine of claim 1, further comprising:
a plurality of sealing rings between the rotor and the engine body, between the bearing and the engine body, and/or between the bearing and the rotor;
an anti-vibration mounting on the engine body; and
an anti-vibration rubber sleeve in the anti-vibration mounting, the anti-vibration mounting and the anti-vibration rubber sleeve being mountable on a vehicle frame.

6. An internal combustion engine, comprising:
an engine body;
a ring-shaped cylinder in the engine body, the ring-shaped cylinder having a center and an outer circumference spaced radially apart from the center;
a plurality of synchronizing valves at least proximate the outer circumference of the ring-shaped cylinder so that the ring-shaped cylinder is divided into a plurality of cylinder portions, the synchronizing valve having a valve shaft and a valve opening; and
a rotor at the center of the ring-shaped cylinder, the rotor having isolation blocks extending from the rotor toward the outer circumference of the ring-shaped chamber, wherein the valve openings are configured to receive the isolation blocks and to form seals in the ring-shaped cylinder.

7. The internal combustion engine of claim 6, further comprising:
a pinion coupled to the synchronizing valve shaft;
an output shaft coupled to the rotor; and
a bull gear coupled to both the output shaft and the pinion.

8. The internal combustion engine of claim 6 wherein:
the isolation block, the synchronizing valve, and the ring-shaped cylinder are configured in such a way that sealing is achieved between the isolation block and the synchronizing valve and between the isolation block and the ring-shaped cylinder;
the internal combustion engine further includes seals on a surface of the isolation block to be at least approximately tangent to the valve opening of the synchronizing valve and the ring-shaped cylinder;
positioning holes in the synchronizing valves, both ends of the seals being locked in the positioning holes; and
springs between both ends of the seals in the positioning holes.

9. The internal combustion engine of claim 1 wherein the synchronizing valve further includes:
a seal having a first end and a second end;
a plurality of positioning holes, both the first and second ends of the seal are locked in the positioning holes; and
a spring between both the first and second ends of the seal in the positioning hole.

10. The internal combustion engine of claim 1, further comprising:
a plurality of sealing rings between the rotor and the engine body, between the bearing and the engine body, and/or between the bearing and the rotor;
an anti-vibration mounting on the engine body; and
an anti-vibration rubber sleeve in the anti-vibration mounting, the anti-vibration mounting and the anti-vibration rubber sleeve being mountable on a vehicle frame.
